(19) United States
(12) Patent Application Publication
(10) Pub. No.: US 2006/0068719 A1
(43) Pub. Date: Mar. 30, 2006

(54) System and method for optimizing a directional communication link

(76) Inventor: Armond Hairapetian, Newport Coast, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/952,971

(22) Filed: Sep. 28, 2004

(51) Int. Cl. H04B 7/00

(52) U.S. Cl. 455/69; 455/126; 455/41.1

(57) ABSTRACT

A feedback link is provided in a directional communication system, such as a millimeter wave communication link, to allow a directional transmitter to optimize an antenna alignment and gain. A remote receiver in the directional link can receive a transmission over the directional link and determine a signal metric, such as received signal strength or data error rate, based on the received signal. The receiver can then couple the signal metric to a feedback transmitter that communicates the signal metric back to the originating directional transmitter using a feedback communication link that is distinct from the directional link. The feedback communication link can be a wireless communication link, such as an IEEE 802.11 wireless communication link. The directional transmitter can receive the signal metric using a receiver coupled to the feedback link. The directional transmitter can adjust a gain or alignment of the antenna based on the signal metric.

### BACKGROUND OF THE DISCLOSURE

Wireless communications allow for establishing communication links without the need to physically route and connect wired infrastructure connecting the endpoints of a communication link. The demands placed on a wireless communication link are typically the same as those placed on a wired link. System providers continually seek to maximize the communication bandwidth available over a link.

Wireless communication links are burdened by constraints not typically found in a wired communication link. A wireless communication system is often constrained to operate within a specified bandwidth of the available spectrum. The spectrum and bandwidth allocation constrains the information bandwidth available over the wireless communication link. While wired communication system may also operate over similar frequency bands, the allocation of spectrum in a wired communication system is often at the discretion of the system operator and not specified by government entities.

Wireless communication systems are also subjected to environmental conditions that affect the wireless communication links in ways typically not experienced in wired communication links. For example, communications in a wireless communication system may be subjected to multipath effects or Doppler. Additionally, depending on the portion of available spectrum allocated to the wireless system, the communication link may be subjected to atmospheric effects, such as atmospheric attenuation.

The bandwidth allocated to a wireless communication system may be a percentage of a center frequency. Thus, communication systems operating at higher frequency bands may be allocated greater absolute bandwidth. For example, a wireless communication system operating at 1 GHz and a 1% bandwidth has 10 MHz of available bandwidth, while a wireless communication system operating at 50 GHz and a 1% bandwidth has 500 MHz of available bandwidth.

However, wireless communication links operating in the millimeter wave bands, generally above 30 GHz, are directional. Therefore, a line of sight (LOS) is typically needed to establish a communication link between a transmitter and corresponding receiver. Aligning and maintaining alignment of a line of sight link between components is important for maintaining high quality communications. Thus, it may be difficult to use millimeter wave wireless communications for various fixed or mobile wireless applications.

It is desirable to be able to establish and maintain an accurate alignment of the directional communication link, such as a line of sight link or a millimeter wave link such that the communication link can be optimized for any particular operating condition. Maintaining alignment between the devices in the wireless communication link allows the receiver to receive the maximum signal to noise available from the link and can contribute to optimizing the communication link.

### BRIEF SUMMARY OF THE DISCLOSURE

Systems, apparatus, and methods for optimizing a directional wireless communication link is disclosed. the directional link can be, for example, a line of sight communication link or a millimeter wave communication link. A feedback link is provided in a directional wireless communication link to allow a directional transmitter to optimize an antenna alignment and gain. A remote receiver in the directional link can receive a transmission over the directional link and determine a signal metric, such as received signal strength or data error rate, based on the received signal. The receiver can then couple the signal metric to a feedback transmitter that communicates the signal metric back to the originating directional transmitter using a feedback communication link that is distinct from the line of sight link. The feedback communication link can be a wireless communication link, such as an IEEE 802.11 wireless communication link. The directional transmitter can receive the signal metric using a receiver coupled to the feedback link. The directional transmitter can adjust a gain or alignment of the antenna based on the signal metric.

In one aspect the disclosure includes a system for optimizing a millimeter wave communication link including a millimeter wave transmitter having a steerable antenna, and configured to transmit a signal over the millimeter wave communication link, and further configured to align the steerable antenna based in part on a feedback signal, a millimeter wave receiver configured to receive the signal transmitted by the millimeter wave transmitter and determine a signal metric based in part on the received signal, a feedback transmitter coupled to the millimeter wave receiver and configured to transmit the signal metric over a feedback link distinct from the millimeter wave communication link, and a feedback receiver coupled to the millimeter wave transmitter and configured to receive the signal metric from the feedback transmitter and communicate the signal metric to the millimeter wave transmitter as the feedback signal.

In another aspect, the disclosure includes a system for optimizing a millimeter wave communication link including a millimeter wave transmitter having a steerable antenna, and configured to transmit a radio signal over a millimeter wave communication link, and further configured to align the steerable antenna based in part on a feedback signal received from a wireless feedback link, a millimeter wave receiver configured to receive the radio signal transmitted by the millimeter wave transmitter and determine a signal metric based in part on the received signal, a wireless feedback transmitter coupled to the millimeter wave receiver and configured to transmit the signal metric over the wireless feedback link distinct from the millimeter wave communication link, and a feedback receiver coupled to the millimeter wave transmitter and configured to receive the signal metric from the feedback transmitter and communicate the signal metric to the millimeter wave transmitter as the feedback signal.

In yet another aspect, the disclosure includes an apparatus for optimizing a millimeter wave communication link including an antenna, a millimeter wave receiver coupled to the steerable antenna and configured receive a signal from a millimeter wave transmitter transmitted over the millimeter wave communication link, and to determine a signal metric based in part on the received signal, and a wireless transmitter coupled to the receiver and configured to transmit the signal metric to a wireless receiver coupled to the millimeter wave transmitter to enable the millimeter wave transmitter to optimize an alignment of a transmit antenna relative to the antenna.

In still another aspect, the disclosure includes a method of optimizing a millimeter wave communication link, including aligning a millimeter wave receiver to a millimeter wave transmitter sufficiently to enable the millimeter wave communication link, and aligning a transmit antenna based in part on a signal metric derived from a signal received by the millimeter wave receiver.

In yet another aspect, the disclosure includes a method of optimizing a millimeter wave communication link, including transmitting a millimeter wave signal over the millimeter wave communication link, receiving a signal metric over a wireless feedback link distinct from the millimeter wave communication link, and adjusting a transmit antenna, based in part on the signal metric, to improve communication over the millimeter wave communication link.

### BRIEF DESCRIPTION OF THE DRAWINGS

The features, objects, and advantages of embodiments of the disclosure will become more apparent from the detailed description set forth below when taken in conjunction with the drawings, in which like elements bear like reference numerals.

FIG. 1 is a functional block diagram of an embodiment of a directional wireless communication system with network feedback.

FIGS. 2A-2C are functional block diagrams of embodiments of a directional wireless communication system with wireless feedback.

FIGS. 3A-3C are functional block diagrams of embodiments of steerable antenna.

FIG. 4A is a flowchart of an embodiment of a process of optimizing a directional communication link.

FIGS. 4B-4C are flowcharts of processes for aligning the directional link.

FIG. 5 is a flowchart of an embodiment of a process of optimizing a directional communication link.

FIG. 6 is a flowchart of an embodiment of a process of optimizing a directional communication link.

### DETAILED DESCRIPTION OF THE DISCLOSURE

Directional wireless communication systems, apparatus, and methods for optimizing communication in a directional wireless communication system are disclosed. The directional communication system is able to optimize alignment and antenna gain in the communication link by utilizing a feedback channel. The directional receiver can determine a signal metric based on a signal received over the directional communication link broadcast by the directional transmitter. The directional receiver can then couple the signal metric to a feedback transmitter that communicates the signal metric back to the directional transmitter. The feedback transmitter can communicate the signal metric on a wireless feedback link that is distinct from the directional communication link. The feedback link can be, for example, an IEEE 802.11 wireless communication link, a Bluetooth™ link, or some other type of wireless communication link.

The directional transmitter can use a receiver that is coupled to the feedback channel to receive the signal metric. The directional transmitter can, for example, reposition an antenna or modify an antenna gain to optimize the directional communication link.

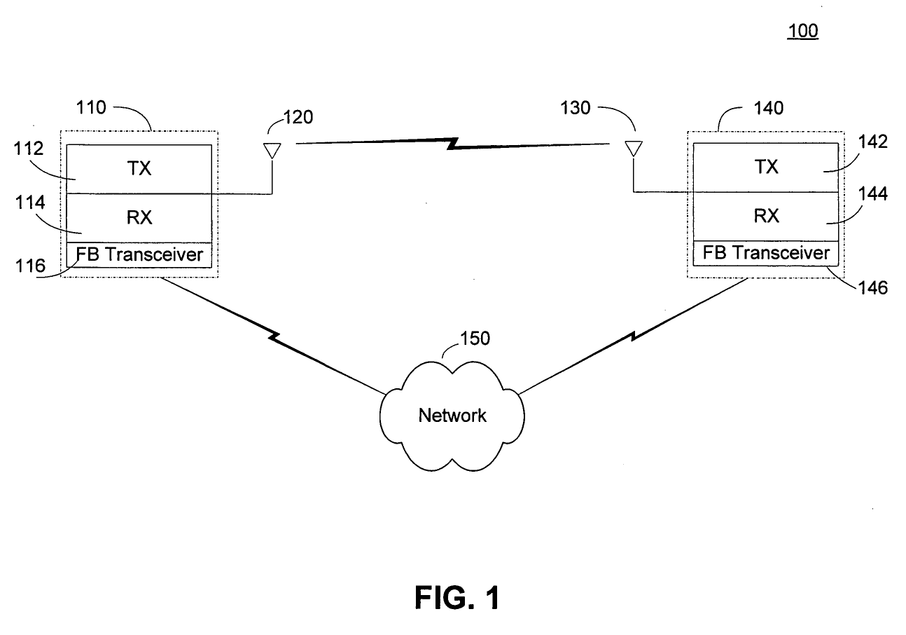

FIG. 1 is a functional block diagram of a directional communication system 100 having a feedback channel that is implemented through a network 150 that is external to the directional communication link. The directional communication system 100 includes a first transceiver 110 that can include a first directional transmitter 112 and a first directional receiver 14 communicating through a common first antenna 120. The first transceiver 110 can also include a feedback receiver within a first feedback transceiver 116 coupled to a network 150, which can be a private network or a public network, such as the Internet.

The directional communication system 100 also includes a second transceiver 140 that includes a second directional transmitter 142 and a second directional receiver 144 coupled to a common second antenna 130. The second transceiver 140 can also include a feedback transmitter within a second feedback transceiver 146 coupled to the network 150.

The first transceiver 110 communicates with the second transceiver 140 over the line of sight communication link through the respective first and second antenna 120 and 130. Because the directional communication link is directional, the antenna, 120 or 130 are typically directional, to reduce the amount of energy that is unnecessarily transmitted along a direction that lacks the ability to be coupled to a destination device. The gain and directivity of the antenna can be increased at a cost of requiring better alignment for optimal performance. A highly directional antenna may experience a substantial reduction in received energy due to misalignment.

Provided the first and second antenna, 120 and 130, are substantially aligned, the first transceiver 110 is able to communicate with the second transceiver 140 over the directional link. However, slight misalignment, due to drift or movement may result in a substantial degradation of the directional communication link. Although the first and second antenna 120 and 130 are shown as single antenna, one or both of the first and second antenna 120 and 130 may be implemented as a plurality of antenna. In such a multiple antenna configuration, the corresponding first or second transceiver 110 or 140 may implement diversity processing.

In order to establish and maintain an optimal alignment, the directional communication system 100 can implement a feedback system. The first directional transceiver 112 can transmit a signal to the second directional receiver 144 over the directional communication link. The signal may be a signal having a predetermined sequence, such as a preamble, or may be the data, symbols, or information being transmitted by the first directional transmitter 112 to the second directional receiver 144.

The second directional receiver 144 can determine a signal metric based on the signal received over the directional communication link. For example, the second directional receiver 144 may determine a received signal strength indication (RSSI) by detecting the received signal power. In other embodiments, the second directional receiver 144 can determine a data error rate, which may be a chip error rate, symbol error rate, or bit error rate associated with the received signal.

The second transceiver 140 may include an internal control loop that operates to optimize the alignment and gain of the second antenna 130 based in part on the value of the signal metric. For example, the second transceiver 140 may realign the second antenna 130 and determine if the realigned second antenna 130 produces an improved signal metric.

The second transceiver 140 can determine that the signal metric is improved based on the measure provided by the signal metric. In the embodiment where the signal metric is an RSSI, the signal metric improves for increasing RSSI. The alignment is optimized for a maximum RSSI value. In contrast, for the embodiments in which the signal metric is an error rate, such as a symbol error rate, the signal metric improves for a decreasing signal metric. The alignment is optimized for a minimum error rate. The second transceiver 140 can continue to optimize the second antenna alignment 130 until an optimal alignment is achieved.

The second transceiver 140 may then be configured to transmit the signal metric to the first transceiver 110 so that the alignment of the first antenna 120 may be optimized. The second directional receiver 144 can couple the signal metric to a feedback transmitter within the second feedback transceiver 146. The feedback transmitter in the second feedback transceiver 146 can transmit the signal metric to the feedback receiver in the first feedback transceiver 116 coupled to the first transceiver 110.

In the embodiment shown in FIG. 1, the feedback transmitter and second feedback transceiver 146 is coupled to a network 150. The feedback transmitter in the second feedback transceiver 146 transmits the signal metric over the network 150 directed to the feedback receiver 116, which is also coupled to the network 150.

The network 150 can be a wired network, a wireless network, or a network having a combination of wired and wireless links. For example, the feedback transmitter in the second feedback transceiver 146 and feedback receiver in the first feedback transceiver 116 can be wired modems and the network 150 may be configured as an Ethernet network.

The feedback receiver in the first feedback transceiver 116 can receive the signal metric and can couple the signal metric to the first directional transmitter 112. The first directional transmitter 112 can realign the first antenna 120 and can monitor the received signal metric for changes. The first directional transmitter 112 can thus be configured to realign the first antenna 120 to optimize the link, based in part on the signal metric received from the second directional receiver 144.

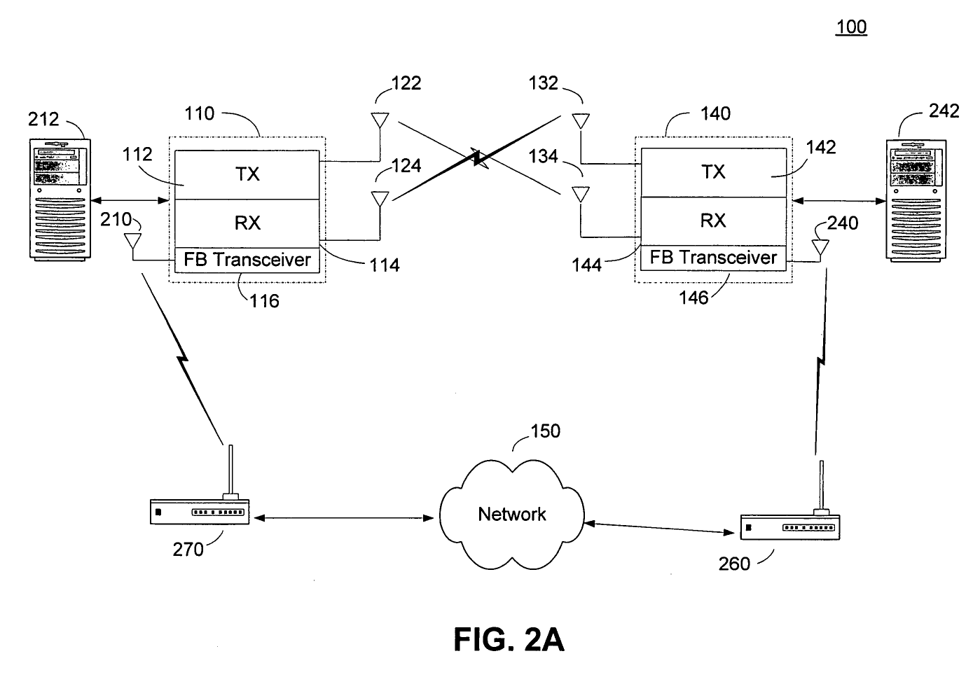

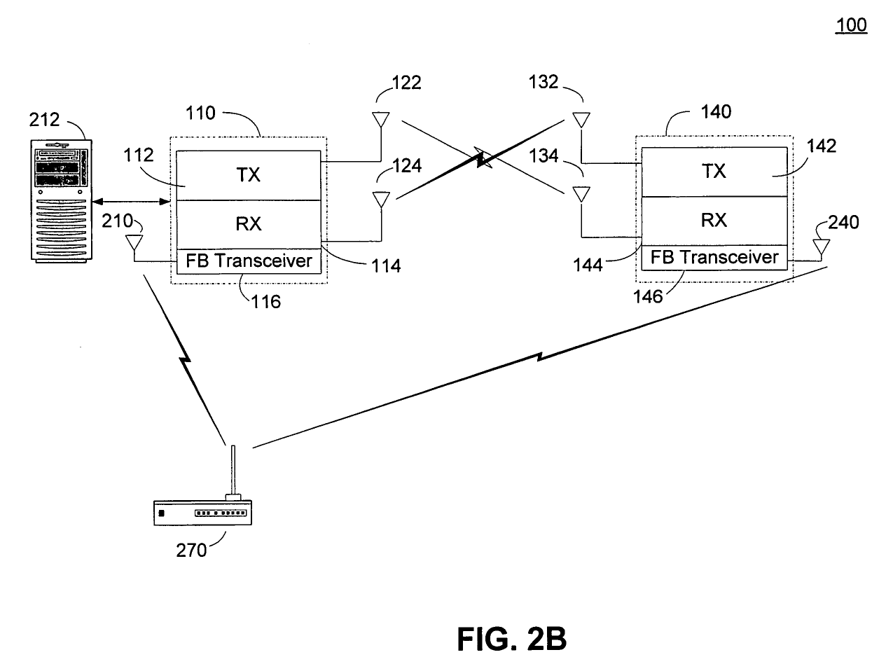

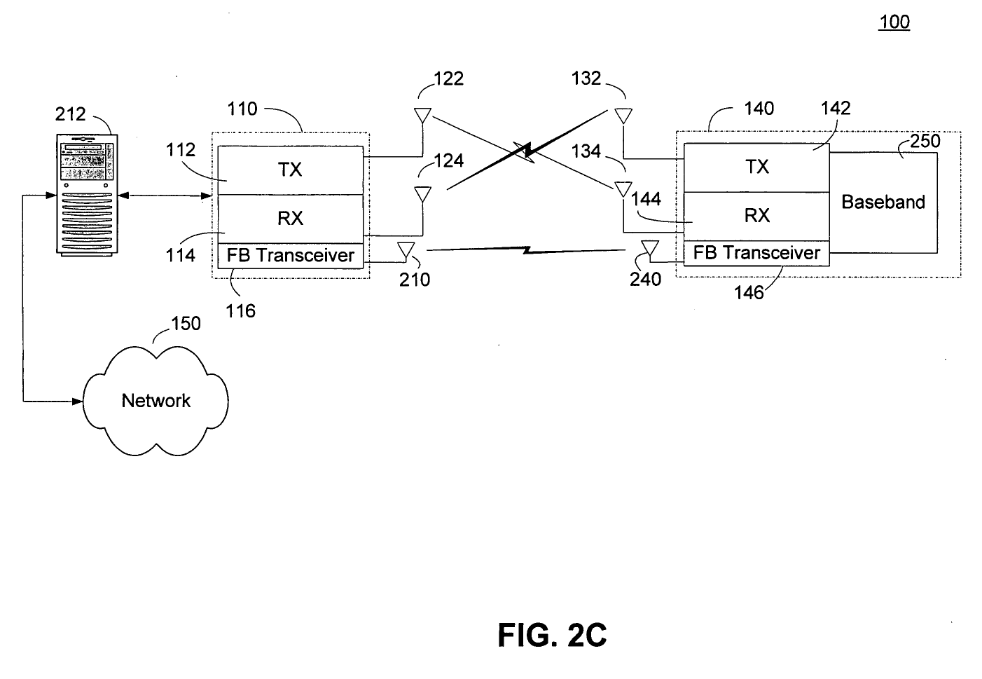

FIG. 2A is a functional block diagram of another embodiment of a directional communication system 100 that can be implemented as a LOS or millimeter wave communication system. As was the case with the previous embodiment, the directional communication system 100 shown in FIG. 2A includes a first transceiver 110 communicating over a directional communication link with a second transceiver 140. A feedback link from the second transceiver 140 to the first transceiver 110 can be used to optimize the directional communication link.

The first transceiver 110 includes a first directional transmitter 112 coupled to a first transmit antenna 122 and a first directional receiver 114 coupled to a first receive antenna 124. The first transceiver 110 also includes a first directional receiver 114 coupled to a first receive antenna 124. The first transceiver 110 includes the feedback receiver 116 coupled to a first feedback antenna 210 and configured to receive the signal metric and communicate the signal metric to the first directional transmitter 110.

The first transceiver 110 can be coupled to a first data processor 212 that can be the source of data for the first directional transmitter 112, and the destination for data received by the first directional receiver 114. The first data processor 212 can be, for example, a server or computer.

The first directional transmitter 112 transmits directional broadcasts, via the first transmit antenna 122 to the second receive antenna 134 coupled to the second directional receiver 144 that is part of the second transceiver 140. The output of the second directional receiver 144 can be coupled to a second data processor 242.

The second data processor 242 can also be a data source for the second directional transmitter 142. The second directional transmitter 142 transmits directional signals, via a second transmit antenna 132, to the first receive antenna 124 and first directional receiver 114. The second transceiver 140 can also include a feedback transmitter that is part of a second feedback transceiver 146 coupled to a second feedback antenna 240.

The feedback channel for the embodiment shown in FIG. 2A includes at least one wireless link distinct from the directional communication link. The second directional receiver 144 determines a signal metric from a signal transmitted by the first directional transmitter 112. The second directional receiver 144 communicates the signal to the feedback transmitter in the second feedback transceiver 146.

The feedback transmitter in the second feedback transceiver 146 wirelessly transmits the signal metric, via the second feedback antenna 240, to a first wireless access point 260. The first wireless access point 260 can be, for example, an access point operating in accordance with an IEEE 802.11 standard.

In one embodiment, the first wireless access point 260 can be coupled to a network 150 via a wired or wireless connection. The network 150 may, in turn, be coupled to a second wireless access point 270 that is configured to transmit the signal metric to the feedback receiver in the first feedback transceiver 116 via the first feedback antenna 210.

In another embodiment, shown in FIG. 2B, the first wireless access point 260 may be configured to receive the feedback signal from the second feedback transceiver 146 and transmit the signal metric directly to the first feedback antenna 210 and feedback receiver in the first feedback transceiver 116 without the need to traverse the network 150 or second wireless access point 270. Additionally, the second transceiver 140 may be a stand alone device and may be the destination for the data and information sent over the directional communication link.

FIG. 2C is a functional block diagram of yet another embodiment of a directional communication system 100. In the embodiment shown in FIG. 2C, the first transceiver 110 can include a first feedback transceiver 116 that is configured to directly communicate with the second feedback transceiver 146 in the second transceiver 140. Thus, the first transceiver 110 effectively incorporates the functionality performed by the access point 260 shown in FIG. 2B. Additionally, the second transceiver 140 can include a baseband module 250 that is configured to process the data communicated over the directional and feedback channels.

In the embodiment shown in FIG. 2C, the first transceiver 110 can be a stationary unit configured, for example, to provide high data rate service within a predefined service area, such as within a business. The first data processor 212 can be, for example, a computer or server that stores accessible files or information, or can be a server that connects the first transceiver 110 to a network 150 that may be a Wide Area Network, such as the Internet. For example, the first data processor 212 can be a server that downloads and stores content accessible from the network 150. The first transceiver 110 can then be configured to provide the stored content over a high speed millimeter wave communication link to the second transceiver 140. Alternatively, the first transceiver 110 can communicate with the network 150 without having to communicate with the first data processor 212, or without the data being processed by the first data processor 212.

The second transceiver 140 can be, for example, a mobile device that is configured to establish a connection with the first transceiver 110 when it is within the predetermined service area. The first transceiver 110 can include, for example, a steerable antenna that can be positioned based in part on the feedback signal provided by the second transceiver 140 using a feedback transmitter in the second feedback transceiver 146. Once the directional communication link is established, data and information can continue to be exchanged over the directional communication link until terminated by the first or second transceivers 110 or 140. Additionally, the directional communication link may be terminated or temporarily interrupted by environmental effects, such as if the directional link is occluded or otherwise degraded. The system may determine that the directional link is degraded, for example, based on a received signal strength, signal to noise ratio, data error rate, and the like, or some other signal characteristic.

In a condition where the directional communication link is interrupted before being terminated, the first and second transceivers 110 and 140 can continue to exchange information, at typically a lower rate, over the feedback channel. Thus, the feedback channel can operate as a secondary or back up communication link for the directional communication link. The first and second transceivers 110 and 140 can each determine if the signal quality exceeds a predetermined threshold. If the signal quality over the directional communication link does not exceed the predetermined threshold, communications can be diverted to the non-directional feedback channel. The first and second transceivers 110 and 140 can periodically attempt to re-establish communications over the directional communication link.

As an example of the embodiment shown in FIG. 2C, the first transceiver 110 can include a first directional transmitter 112 and first directional receiver 114 that are configured to operate in a unlicensed portion of a millimeter wave spectrum. The first feedback transceiver 116 can operate in a lower unlicensed frequency band that is not as directional as the directional communication link. For example, the first feedback transceiver 116 can be a wireless access point of an IEEE 802.11 communication system or can be a Bluetooth wireless access point. The first transceiver 110 can be configured to provide high speed data communications at a predetermined service area.

The second transceiver 140 can be a mobile device that is configured to operate over the directional communication link as well as over the feedback channel, which may be a non-directional communication link. For example, the second transceiver 140 can be a portable computer that is configured with a wireless modem configured to operate over the directional and feedback links. In other examples, the second transceiver 140 can be a portable phone or portable data device that is configured to operate over both the directional and feedback links.

When the second transceiver 140 initially enters the predetermined service area, it may initially establish a link with the first transceiver 110 using either the directional communication link or the feedback communication link. If the communication link is initially established over the directional communication link, the second transceiver 140 may optimize the directional communication link using the feedback channel.

Alternatively, the second transceiver 140 may initially establish communications with the first transceiver 110 over the feedback channel. The first transceiver 110 may inform the second transceiver 140, over the feedback channel, of the availability of the directional communication link. The first transceiver 110 and second transceiver 140 may then establish the directional communication link and optimize the link using the signal metric transmitted over the feedback channel.

The feedback channel does not need to be a high bandwidth link because of the limited amount of information being communicated over the channel. Additionally, the latency through the channel may not be an issue if the alignment of the directional communication link is stable relative to the latency through the feedback channel. However, in the embodiment where the feedback channel is configured as a back up channel to the directional communication link, it may be advantageous for the feedback channel to have a sufficient bandwidth to accommodate the information diverted from the directional communication link. Of course, the feedback channel need not provide a bandwidth equivalent to the directional communication channel.

Even misaligned directional transceivers 110 and 140 may be optimized using the feedback channel. It may be advantageous to implement the feedback channel in a wireless communication link that is within a frequency band that is tolerant to misalignments, such as those operating in non-directional frequency bands lower than the millimeter wave frequency bands.

If, for example, the directional antenna gain can be varied by varying the directivity of the antenna, the antenna can initially be set up with low directivity. Then the directional transceivers 110 and 140 can be configured to transmit the signal metric over the feedback channel in order to optimize the directional communication link. The directional transmitter 112 can then adjust the gain and directivity of the first transmit antenna 122 to optimize the directional communication link. The directivity of the first transmit antenna 122 can continue to be increased, for example, until a predetermined gain limit is achieved. The other antenna can similarly be adjusted to optimize the directional communications in both directions.

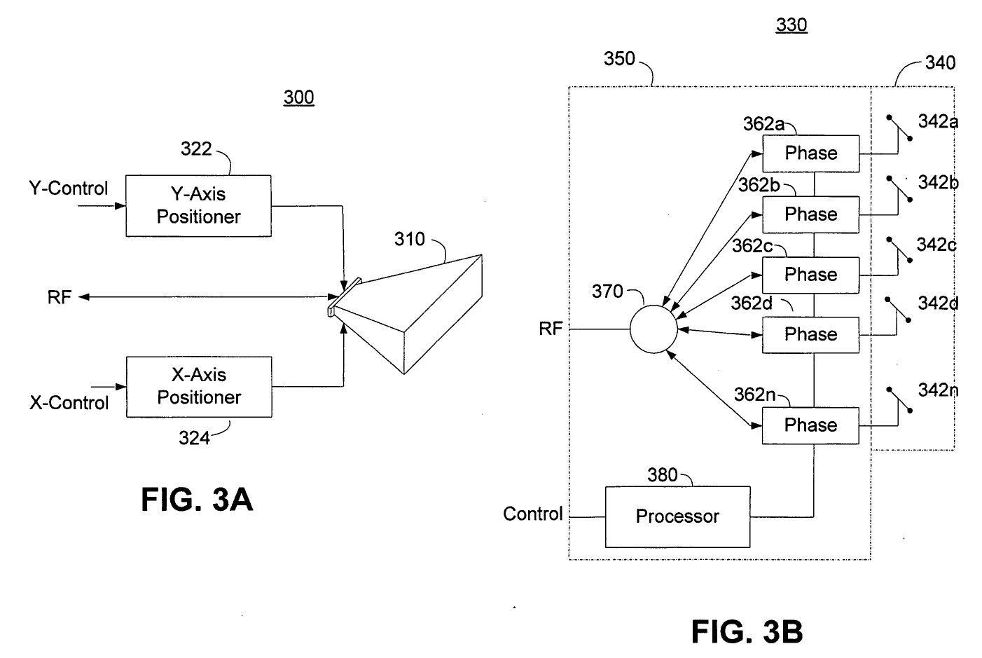

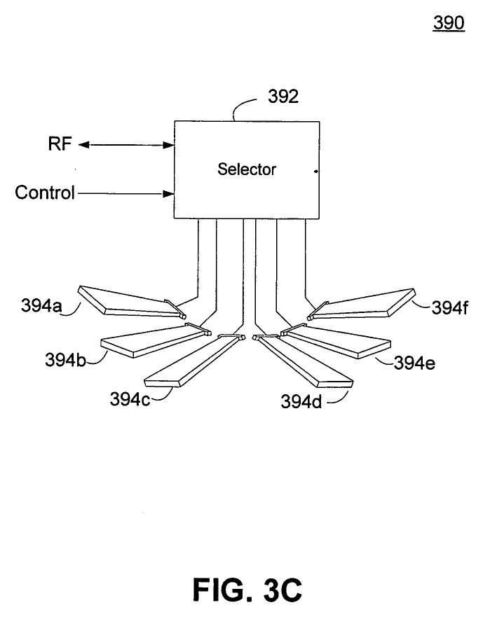

The antenna shown in FIGS. 1 and 2A-2C can be implemented in various configurations. FIGS. 3A-3C are functional block diagrams of antenna embodiments that allow the alignment of the antenna to be adjusted.

The antenna 300 embodiment of FIG. 3A represents an example of a mechanically steerable antenna, while the antenna 330 embodiment of FIG. 3B represents an example of an electronically steerable antenna.

FIG. 3A is a functional block diagram of an embodiment of an antenna 300 that can be used, for example as a steerable directional transmit or receive antenna shown in the directional communication systems 100 of FIGS. 1 and 2A-2C. The antenna includes feed coupled to a collector or reflector portion, here shown as a horn 310, and one or more mechanical positioners.

The antenna 300 of FIG. 3A includes two mechanical positioners. The mechanical positioners include an x-axis positioner 324 and a y-axis positioner 322. The x-axis positioner 324 can be configured, for example to rotate the horn 310 about the x-axis, while the y-axis positioner 322 can be configured to rotate the horn 310 about the y-axis.

The combination of the two positioners 322 and 324 allows the antenna 300 to be aligned to a source or target while maintaining a relatively low beam width and high antenna gain. Because the horn 310 is typically a fixed shape, the antenna 300 embodiment may not have the ability to alter the antenna gain.

FIG. 3B is a functional block diagram of an antenna 330 that can be electronically steered. The antenna 330 includes an antenna array 340 coupled to feed electronics 350. The antenna array 340 is shown as including several dipole antenna elements 342a-342n. However, the antenna array 340 may be an array of other types of antenna elements. For example, the antenna array 340 can be an array of monopoles, or a patch antenna having an array of segments.

The feed electronics 350 includes RF and control inputs and provides appropriate signals to the antenna array 340. The inputs to each of the antenna elements 342a-342n in the antenna array 340 is driven by an output of the feed electronics 350.

The feed electronics 350 include a RF signal splitter 370 coupled to the RF input and configured to split the input signal into at least enough outputs to support the number of inputs to the antenna array 340. Each of the outputs from the signal splitter 370 is coupled to a corresponding phase shifter, 362a-362n. Each of the phase shifters, for example 362a, can be configured to shift its associated RF signal by a phase determined in part by a control signal. The phase shifter 362a may also be configured to provide a signal gain according to the control signal. Each phase shifter output is coupled to a corresponding antenna input of the antenna array 340.

The feed electronics 350 also includes a control input configured to receive control messages and data from, for example, an associated directional transmitter. The control message can indicate, for example, a desired antenna gain and orientation for an antenna beam. The processor 380 can receive the control message and transform the message to the appropriate control signals for each of the phase shifters 362a-362n in order to generate the desired antenna beam having the desired antenna gain.

FIG. 3C is a functional block diagram of another steerable antenna 390 embodiment. The antenna 390 of FIG. 3C can be used, for example, as one of the antenna shown in the directional communication systems 100 of FIGS. 1 and 2A-2C. The steerable antenna 390 includes a plurality of antenna 394a-394f positioned along different directions. The steerable antenna 390 also includes a selector 392 configured to select one or more of the plurality of antenna 394a-394f. Although six directional antenna 394a-394f are shown in the embodiment of FIG. 3C, it is understood that any number of antenna can be used to support a desired coverage area. Additionally, although the antenna 394a-394f are shown as fixed position antenna, one or more of the antenna 394a-394f may also be a steerable antenna.

The selector 392 can be controlled using a control input signal to select one or more of the antenna 394a-394f. For example, when initially establishing a link, the selector 392 may be configured to select multiple antenna 394a-394f and may select all of the available antenna 394a-394f. As the directional link is optimized, the selector 392 may be configured to select as few as one of the antenna, for example 394a.

Alternatively, the selector 392 may be configured to select only one of the antenna 394a-394f and the selector 392 may be configured to select the antenna 394a-394f according to a predetermined search routine during a period in which the directional communication link is established.

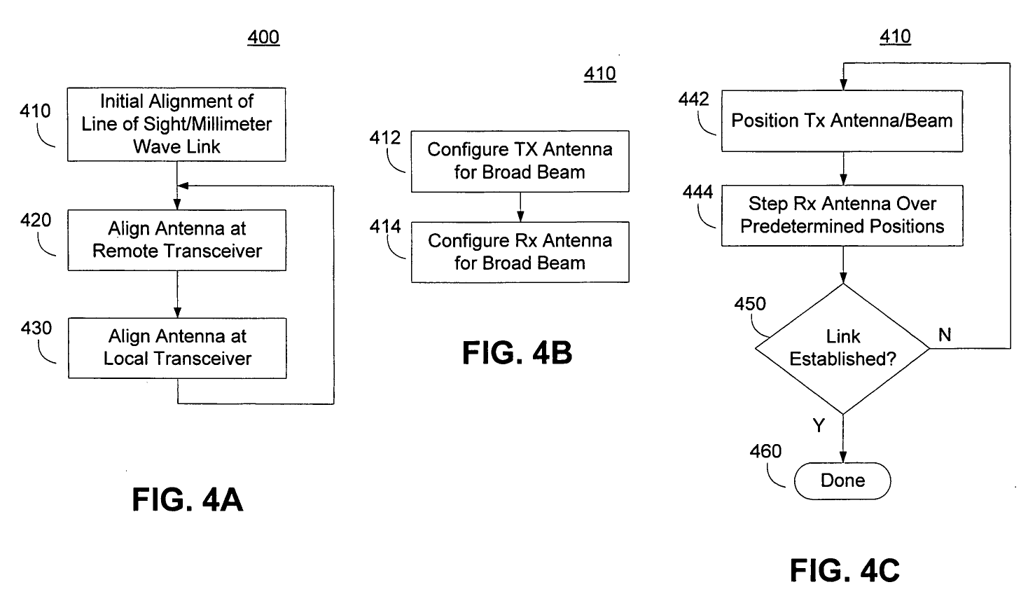

FIG. 4A is a flowchart of an embodiment of a method 400 of optimizing a directional communication link by aligning the remote and local antenna. The method 400 can be performed, for example, by the directional transceivers in the directional communication systems shown in FIGS. 1 and 2.

The method 400 begins at block 410 where the system initially aligns the local and remote transceivers in the directional communication link. The transceivers may need to be aligned manually if the antenna on the transceivers do not have a large beamwidth. Alternatively, the transceivers may be aligned automatically using mechanical, electrical, or a combination of mechanical and electrical processes. For example, in one embodiment, the transceivers may initially communicate over a lower frequency communication link. The transceivers may communicate the ability to communicate over a directional communication link, such as a millimeter wave link or a LOS communication link. The transceivers can then initialize operation over the directional communication link. As discussed earlier, communicating over a higher frequency directional communication link may be advantageous because of additional bandwidth available at the higher frequency directional communication link.

Once the transceivers are initially aligned, the system can begin optimizing the directional communication link. Alternatively, even if the directional communication link is not sufficiently aligned to allow communications, the system can proceed with the alignment portion of the method 400 provided communication over the feedback link is maintained. At block 420, the system can optimize the communication link by aligning the antenna at the remote transceiver. For example, the remote transceiver can be configured to determine a signal metric based on the received directional signal from the associated local transmitter. The remote transceiver can then align its antenna to optimize the signal metric. Optimizing the alignment can include the physical beam alignment as well as increasing a gain or directivity to a desired level. Once the remote antenna is aligned, the system can proceed to block 430.

In block 430, the local transceiver can align its antenna. As discussed above, the local transceiver can align its antenna by receiving a signal metric transmitted by the remote transceiver over a feedback channel distinct from the directional communication link.

Once the local transceiver is finished aligning its antenna, the communication link is optimized. The system can continue the method 400 by returning to block 420 to again align the remote antenna. For example, the system may be configured to periodically repeat the alignment process. The system may, for example, optimize the alignment over a period of fractions of a second, a second, multiples of a second, an hour, multiples of an hour, a day, a week, a month, or some other time interval.

FIG. 4B is a flowchart of an embodiment of a process 410 for electronically aligning the directional link between transceivers. The process 410 can be performed, for example, by one or both of the two transceivers establishing the directional link. Each of the transceivers can have an electronically steerable antenna, such as the antenna shown in FIG. 3B or 3C. Each of the transceivers may independently perform the process 410, or if only one of the transceivers includes steerable antenna, the transceiver with the steerable antenna may perform the process 410.

The process 410 begins at block 412 where the transceiver configures the transmit antenna for a broad beam pattern. Where the transmit antenna is a phased array antenna, such as shown in FIG. 3B, the transceiver may electronically configure the beamwidth of the antenna. Where the transmit antenna includes a selectable antenna array, such as shown in FIG. 3C, the transceiver can configure the selector to select all or multiple antenna. The broad beamwidth may reduce the antenna gain, but maximizes the region illuminated by the transmitter.

The transceiver then proceeds to block 414 and similarly configures the receive antenna for a broad beamwidth to enable the transceiver to receive signals from any direction within the antenna beam.

FIG. 4C is a flowchart of another embodiment of a process 410 for electronically aligning the directional link between transceivers. As before, the process 410 can be performed, for example, by one or both of the two transceivers establishing the directional link. The process 410 of FIG. 4C implements a search of an area that is supported by the antenna in order to establish the directional link.

The process 410 begins at block 442 where a first transceiver can configure its transmit antenna for a particular position. The antenna can be, for example, a mechanically steerable antenna or may be an array of selectable antenna where only a subset of positions may be selected at any instant.

The transceiver can then configure the receive antenna to search or step over a predetermined number of positions. The predetermined number of positions may correspond to all possible antenna for an array of antenna, or may correspond to a predetermined set of positions for a mechanically steerable antenna.

The transceiver then proceeds to decision block 450 and determines if a link has been established. If a link has been established, the process 410 is done 460. Alternatively, if the link has not yet been established with the transmit antenna position, the transceiver returns to block 442 and repositions the transmit antenna to the next position of a predetermined sequence of positions. The process flow may repeat until a link is established.

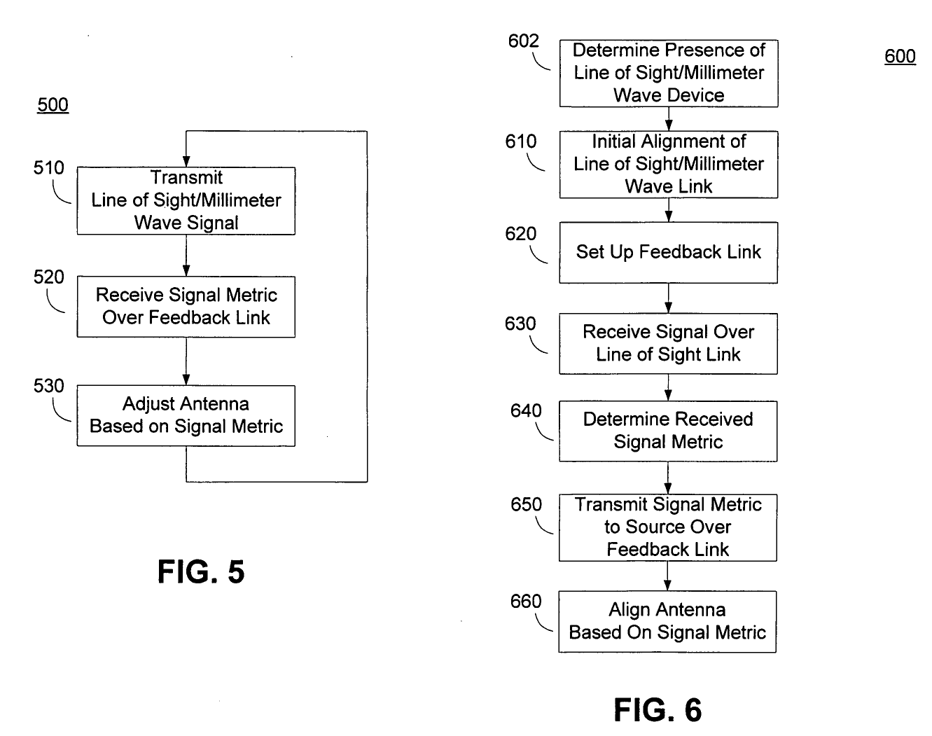

FIG. 5 is a flowchart of an embodiment of a method 500 of optimizing a transmit antenna based on a signal metric generated at a remote location. The method 500 may be performed by any transceiver configured to receive a feedback signal over a feedback channel. For example, the first transceiver of FIG. 1 or FIG. 2 can perform the method 500 of FIG. 5.

The method 500 begins at block 510 where the transmitter within the transceiver transmits a directional signal to a corresponding directional receiver. The directional signal can be, for example, a millimeter wave signal or a LOS signal. The signal can be the data signal that is being communicated to a remote location, or can be a predetermined sequence that is used for optimization of the directional communication link.

The transceiver then proceeds to block 520 where it receives a signal metric generated by the directional receiver. The transceiver can be configured to receive the signal metric over a feedback channel, which may be a wireless feedback channel over a IEEE 802.11 communication link.

Once the signal metric is received by the transceiver, the transceiver proceeds to block 530 and adjusts the antenna, based in part on the value of the signal metric. In one embodiment, the transceiver can adjust the antenna gain or alignment and can determine an improvement based on a change in the signal metric. If the signal metric degrades, the transceiver can determine that the change to the antenna alignment was non-optimal, and may have been in the wrong direction. In contrast, if the signal metric improves, the transceiver may continue to steer the antenna in the direction that resulted in the prior improvement.

The transceiver can be configured to steer the antenna using a predetermined pattern or schedule of directions. For example, the transceiver may steer the antenna in an x-direction prior to aligning the antenna in a y-direction and may iteratively align the x and y position of the antenna beam until the beam is optimized. Thus, after adjusting the antenna beam, the transceiver may return to block 510 and continue transmitting to the directional receiver.

FIG. 6 is a flowchart of a method 600 of optimizing a directional communication link using a feedback signal transmitted on a feedback channel. The method 600 can be performed, for example, by the directional system of FIG. 1 or FIG. 2.

The method begins at block 602 where the communication devices, such as the transceivers of FIGS. 1 and 2, determine the presence of a device that is configured to communicate over the directional link. For example, the transceivers may initially communicate over a lower frequency link, such as an IEEE 802.11 communication link, and may communicate the ability to utilize a directional communication link. The transceivers can continue to communicate over the lower frequency link while the directional link is established and optimized. The system then proceeds to block 610 where the directional transmitter and corresponding directional receiver are aligned. The initial alignment and establishment of the directional link can be performed manually or may be performed automatically, for example, using one of the processes shown in FIG. 4B or 4C.

In one embodiment, the initial alignment refers to a default antenna configuration on each of the transceivers participating in the directional communication link. In some situations, the default antenna alignment may result in a directional communication link that is not able to establish or maintain communications because of significant misalignment. However, if an alternative link, such as the initial lower frequency link, is established, the system can align the directional communication link.

The directional communication link can be, for example, a millimeter wave communication system. In one embodiment, the directional communication link is a millimeter wave link operating within the band of 50 GHz-90 GHz. More particularly, the directional communication link can be an unlicensed millimeter wave communication link operating in the 57 GHz-64 GHz frequency band.

The system then proceeds to block 620 where the directional transmitter and directional receiver are configured for access to the feedback link and the feedback channel. For example, a feedback transmitter and feedback receiver coupled, respectively, to the directional receiver and directional transmitter can be configured to access a network or a wireless access point. In one embodiment, the directional transceivers can be configured to access corresponding wireless access points of an IEEE 802.11 wireless communication system coupled to a network.

The system then proceeds to block 630 where the directional receiver receives one or more signal transmitted by the directional transmitter. The receiver proceeds to block 640 where the directional receiver determines a signal metric based on the received signal. The signal metric can be, for example, a received signal strength, a data error rate, and the like or some other measure of the signal.

The directional receiver proceeds to block 650 and transmits the signal metric to the directional transmitter using the feedback transmitter and feedback channel. The system proceeds to block 660 and the transmit antenna is aligned based at least in part on the signal metric.

Line of sight systems, apparatus, and methods have thus been disclosed that provide for optimizing the line of sight communication link using a feedback signal that is delivered via a feedback channel that is separate from the directional wireless link. Using the proposed systems, apparatus, and methods, millimeter wave communication links can be set up and maintained automatically. The millimeter wave spectrum can thus be practical for various mobile and fixed point applications. By using low cost IEEE 802.11 LAN for link establishment and management, the amount of hardware operating at millimeter wave frequencies is reduced, which can in turn reduce overall system cost.

The above description of the disclosed embodiments is provided to enable any person skilled in the art to make or use the disclosure. Various modifications to these embodiments will be readily apparent to those skilled in the art, and the generic principles defined herein may be applied to other embodiments without departing from the scope of the disclosure. Thus, the disclosure is not intended to be limited to the embodiments shown herein but is to be accorded the widest scope consistent with the principles and novel features disclosed herein.

What is claimed is:

1. A system for optimizing a directional communication link, the system comprising:
a directional transmitter having a steerable antenna, and configured to transmit a signal over the directional communication link, and further configured to align the steerable antenna based in part on a feedback signal;
a directional receiver configured to receive the signal transmitted by the directional transmitter and determine a signal metric based in part on the received signal;
a feedback transmitter coupled to the directional receiver and configured to transmit the signal metric over a feedback link distinct from the directional communication link; and
a feedback receiver coupled to the directional transmitter and configured to receive the signal metric from the feedback transmitter and communicate the signal metric to the directional transmitter as the feedback signal.

2. The system of claim 1, wherein the steerable antenna comprises a mechanically steerable antenna.

3. The system of claim 1, wherein the steerable antenna comprises an electronically steerable antenna array.

4. The system of claim 1, wherein the steerable antenna comprises a selectable array of directional antenna.

5. The system of claim 1, wherein the directional transmitter is configured to align the steerable antenna to maximize the signal metric.

6. The system of claim 1, wherein the directional transmitter is configured to align the steerable antenna to minimize the signal metric.

7. The system of claim 1, wherein the directional transmitter is configured to transmit the signal within the 50 GHz to 90 GHz frequency band.

8. The system of claim 1, wherein the signal metric comprises a received signal strength indication (RSSI).

9. The system of claim 1, wherein the signal metric comprises an error rate of the received signal.

10. The system of claim 1, wherein the feedback link comprises a wireless link.

11. The system of claim 1, wherein the feedback link comprises a wired network link.

12. The system of claim 1, wherein the feedback link comprises an RF link operating in an unlicensed spectrum.

13. The system of claim 1, wherein the feedback transmitter comprises an RF transmitter configured to operate according to an IEEE 802.11 standard.

14. The system of claim 1, wherein the directional communication link comprises a millimeter wave communication link.

15. A system for optimizing a millimeter wave communication link, the system comprising:
a millimeter wave transmitter having a steerable antenna, and configured to transmit a radio signal over a millimeter wave communication link, and further configured to align the steerable antenna based in part on a feedback signal received from a wireless feedback link;
a millimeter wave receiver configured to receive the radio signal transmitted by the millimeter wave transmitter and determine a signal metric based in part on the received signal;
a first wireless feedback transmitter coupled to the millimeter wave receiver and configured to transmit the signal metric over the wireless feedback link distinct from the millimeter wave communication link; and
a first feedback receiver coupled to the millimeter wave transmitter and configured to receive the signal metric from the feedback transmitter and communicate the signal metric to the millimeter wave transmitter as the feedback signal.

16. The system of claim 15, further comprising:
a second wireless feedback transmitter coupled to the millimeter wave transmitter; and
a second feedback receiver coupled to the millimeter wave receiver;
wherein the system is configured to communicate over the wireless feedback link using the first and second wireless feedback transmitters and first and second feedback receivers if the millimeter wave communication link is degraded.

17. An apparatus for optimizing a millimeter wave communication link, the apparatus comprising:
a steerable antenna;
a millimeter wave receiver coupled to the steerable antenna and configured receive a signal from a millimeter wave transmitter transmitted over the millimeter wave communication link, and to determine a signal metric based in part on the received signal; and
a wireless transmitter coupled to the receiver and configured to transmit the signal metric to a wireless receiver coupled to the millimeter wave transmitter to enable the millimeter wave transmitter to optimize an alignment of a transmit antenna relative to the steerable antenna.

18. A method of optimizing a directional communication link, the method comprising:
aligning a directional receiver to a directional transmitter sufficiently to enable the directional communication link; and
aligning a transmit antenna based in part on a signal metric derived from a signal received by the directional receiver.

19. The method of claim 18, further comprising communicating over a feedback channel distinct from the directional communication link if the directional communication link is degraded.

20. The method of claim 18, wherein aligning the transmit antenna comprises:
receiving the signal metric over a wireless link distinct from the directional communication link; and
aligning the transmit antenna to achieve a predetermined optimum signal metric.

21. The method of claim 20, wherein the predetermined optimum signal metric comprises a minimum signal metric.

22. The method of claim 20, wherein the predetermined optimum signal metric comprises a maximum signal metric.

23. The method of claim 18, wherein aligning the transmit antenna comprises mechanically positioning the transmit antenna.

24. The method of claim 18, wherein aligning the transmit antenna comprises electronically aligning a transmit antenna beam.

25. A method of optimizing a directional communication link, the method comprising:
transmitting a directional signal over the directional communication link;
receiving a signal metric over a wireless feedback link distinct from the directional communication link; and
adjusting a transmit antenna, based in part on the signal metric, to improve communication over the directional communication link.

26. A method of optimizing a millimeter wave communication link, the method comprising:
receiving a signal over the millimeter wave communication link from a millimeter wave transmitter;
determining a signal metric based in part on the signal;
transmitting the signal metric to the millimeter wave transmitter over a feedback link distinct from the millimeter wave communication link.

27. A method of optimizing a millimeter wave communication link, the method comprising:
establishing a non-directional communication link;
communicating, over the non-directional communication link, an ability to operate over a directional communication link;
initializing communications over the directional communication link; and
optimizing operation of the directional communication link, in part, using a signal metric communicated over the non-directional communication link.

28. The method of claim 27, further comprising communicating over the non-directional communication link if a signal quality over the directional communication link is less than predetermined threshold.

29. The method of claim 27, wherein the non-directional communication link comprises a wireless communication link and the directional communication link comprises a millimeter wave communication link.

30. A method of optimizing a millimeter wave communication link, the method comprising:
receiving a transmission over a wireless communication link indicating availability of a millimeter wave communication link;
establishing communications over the millimeter wave communication link, establishing communications comprising:
receiving a signal over the millimeter wave communication link from a millimeter wave transmitter;
determining a signal metric based in part on the signal; and
transmitting the signal metric to the millimeter wave transmitter over the wireless communication link distinct from the millimeter wave communication link to optimize communications over the millimeter wave communication link; and
communicating data over the wireless communication link rather than the millimeter wave communication link if the signal metric is less than a predetermined threshold.
